(19) United States
(12) Patent Application Publication
(10) Pub. No.: US 2015/0154259 A1
(43) Pub. Date: Jun. 4, 2015

(54) SQL QUERY ON A NOSQL DATABASE

(71) Applicant: Hewlett-Packard Development Company, L.P., Houston, TX (US)

(72) Inventors: Kimberly Keeton, San Francisco, CA (US); Craig A. Soules, San Francisco, CA (US); Devaraj Daimane, Bangalore (IN); Charles Stuart Johnson, San Jose, CA (US)

(73) Assignee: Hewlett-Packard Development Company, L.P., Houston, TX (US)

(21) Appl. No.: 14/095,672

(22) Filed: Dec. 3, 2013

(51) Int. Cl. G06F 17/30

(52) U.S. Cl. CPC G06F 17/30477; G06F 17/30339

(57) ABSTRACT

A computing system can include a processor to execute stored instructions and a memory that stores instructions. The memory can include computer-implemented code to receive a structured query language (SQL) query requesting data from a non-structured query language (NoSQL) database. The memory can also include computer-implemented code to identify a query qualification and a related table in a NoSQL database. The memory can further include computer-implemented code to determine a row iterator class and computer-implemented code to access the identified related table. Additionally, the memory can include computer-implemented code to return the requested data.

### BACKGROUND

A traditional structured query language (SQL) database is a relational database in which a collection of tables of data items are organized according to the relational model. Relationships can be defined between rows of the tables. A non-structured query language (NoSQL) database stores and retrieves data in a less constrained way than an SQL database.

### BRIEF DESCRIPTION OF THE DRAWINGS

Certain examples are described in the following detailed description and in reference to the drawings, in which:

FIG. 1 is a block diagram of an example of a computing system in accordance with the techniques of the present application;

FIG. 2 is a block diagram of a tangible, non-transitory, machine-readable medium containing code for processing an SQL query to access a NoSQL database in accordance with an example of the techniques of the present application; and

FIG. 3 is a process flow diagram of an example of a method of processing an SQL query to access a NoSQL database in accordance with an example of the techniques of the present application.

### DETAILED DESCRIPTION OF SPECIFIC EMBODIMENTS

Traditional SQL databases can be built using an iterator model, where operators in the query plan (e.g., table scan, join, sort, etc.) are connected in a tree topology, with nodes at the leaves of the tree producing tuples for the consumer nodes higher in the tree. This model is pull-based, in that a consumer node pulls data one row (tuple) at a time from its producer(s) to accomplish its task. For maximal generality, attributes in a row are treated as general data types, which are unpacked to be accessed as their intrinsic data types. Data sources (e.g., leaf nodes of the query execution tree) are natively defined tables (often stored as files in the underlying file system), materialized views, or indexes on natively defined tables. They can also be “foreign” data sources which are stored outside the database (e.g., in a non-native file format or in an external database). Accesses to these “foreign” data sources are made on a “table-by-table” basis, rather than on a transactional basis.

In contrast, NoSQL databases use highly efficient storage layers that access data on a page granularity, using compression to increase the efficiency of transferring pages from disk. To further improve data efficiency, NoSQL databases use data type-specific code to manipulate the values stored within these pages. NoSQL databases can also use a form of indexing to minimize the number of pages to be accessed when processing a query with search qualifications (e.g., conditions in a SQL SELECT WHERE {conditions} statement). Rather than relying on traditional B-trees (as SQL databases typically do), which employ disk accesses to read the leaf nodes of the index, NoSQL indexes are designed to fit entirely into memory, for example by storing the minimum and maximum values of the search key in each page.

A functionally decoupled NoSQL database is a database in which querying of the data is handled separately from ingestion of new and/or modified data. In this environment, updates are processed and periodically made visible to lookup queries, which see a consistent, but possibly out-of-date, view of the data. Rather than relying on fine-grained locking to update data, NoSQL databases will batch together updates and apply them atomically, only exposing the results to read queries when the batch has been applied. This method of batch updates can result in a property called snapshot isolation consistency when updates that arrive after a read-only query starts are not incorporated into the result set for the query, where a user read query sees the state of the database at the time the original request was sent, rather than seeing any database updates while the query consumes a result set.

These properties lead to several challenges in trying to permit an SQL lookup query in a functionally decoupled NoSQL database. These challenges include row versus extent data access. SQL databases use pull-based row iterators, while NoSQL data storage layers use page granularity access. An additional challenge is general versus data type-specific values and processing. SQL databases use general types for generality, while NoSQL databases use data type-specific values and processing for efficiency. A further challenge is per-table versus per-transaction access. SQL databases access external data sources once per table. As a result, foreign table accesses need to be coordinated to provide a consistent database view on a transaction basis.

Previous NoSQL database queries have been implemented by writing query handlers in a high-level language (e.g., C++). However, using this approach, users cannot write queries in a declarative language like SQL, and a new handler is written for each new query. Alternately, data has been imported from an external data source (e.g., DataSeries) and the tables operated on in the native format. However, this approach does not permit easy updates to the underlying data source files from the ingestion path of the database. Furthermore, this approach can incur increased storage costs because tables will no longer be able to leverage the data source's efficiency techniques (e.g., compression, min-max indexes). In another alternative, a user can use the SQL parser from an existing relational database management system (RDBMS) and build a new data-specific storage layer, query operators, query execution engine, and query optimizer. However, this approach uses significant development effort and results in increased costs.

To overcome these challenges and the deficiencies of these previous solutions, a multi-layer approach is employed to satisfy an SQL lookup (i.e., read-only) query in the context of a functionally decoupled NoSQL database built on an efficient storage layer. A multi-layer query executor can include a query analyzer layer to analyze an SQL query from a client, a row iterator layer to access the data requested in a query from an NoSQL database, and a translator layer to translate between the query analyzer and the row iterator.

The query executor can be employed by a variety of database management systems (DBMSs). For example, the query executor can be employed in a system employing PostgreSQL as a DBMS. PostgreSQL is an open source RDBMS that provides a foreign data wrapper interface that permits developers to wrap external file formats and servers in PorsgreSQL's row-based iterator model. With PostgreSQL's row-based iterator model, for each relation scan in the query plan, the corresponding file is opened and sequentially scanned to return data one row at a time.

Further, the example computing system can employ DataSeries. DataSeries is an open-source compressed table-based storage layer that stores sets of rows into large pages called extents, which are individually compressed. DataSeries provides extent indexes that store the minimum and maximum values of the search key in each extent; these indexes can be used to efficiently determine which extents satisfy the qualifications of a query, thus providing performance improvements for highly selective queries. Extent indexes support equality, range, and set searches.

In this example employing PostgreSQL and DataSeries, PostgreSQL can be employed as a query front end. The query executor can include a foreign data wrapper (FDW) (i.e., query analyzer) to interface with PostgreSQL. The query executor can also include a DataSeries (DS) row-level iterator to interface with DataSeries files. Additionally, the query executor can include a shim layer to translate between the foreign data wrapper and the row-level iterator.Both the translation shim and the DataSeries row iterator layers use schema- and data-type-specific code. This code can be automatically generated based on a C++ code template and an XML schema specification. Employing this query executor, queries can take advantage of DataSeries extent indexes to avoid unnecessarily reading unresponsive extents from disk. Because tables are maintained in their DataSeries format, the tables can leverage DataSeries extent compression schemes to reduce disk bandwidth and on-disk space consumption.

This multi-layer query executor permits users to write lookup queries in SQL, while permitting updates to the underlying NoSQL database through the ingestion path. Further, the multi-layer query executor uses basic data types rather than generalized data types, resulting in faster table scans. Additionally, only localized modifications to the existing code base are employed, dramatically reducing development effort and, subsequently reducing development costs.

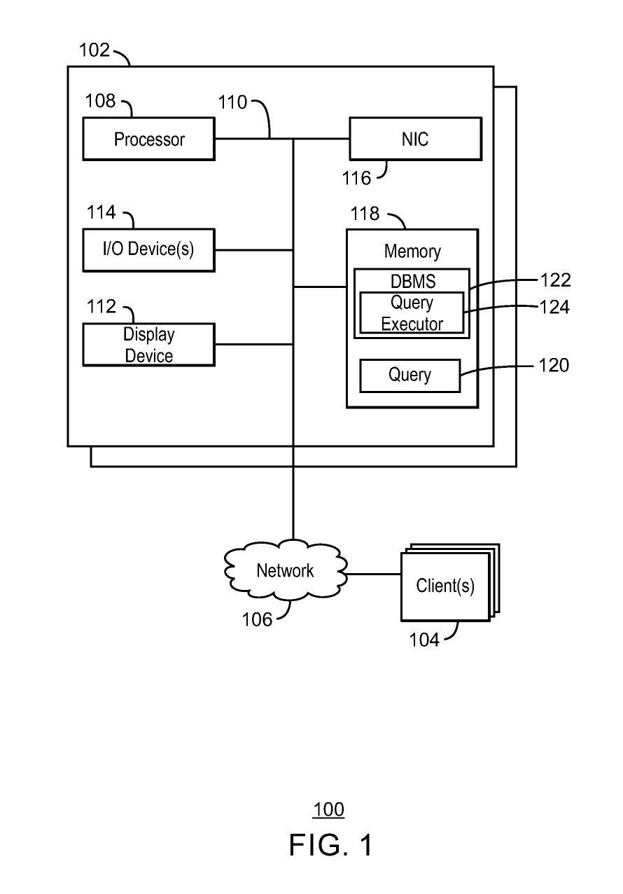

FIG. 1 is a block diagram of an example of a computing system in accordance with an example of the techniques of the present application. The functional blocks and devices shown in FIG. 1 can include hardware elements, software elements, or some combination of software and hardware. The hardware elements can include circuitry. The software elements can include computer code stored as machine-readable instructions on a tangible, non-transitory, machine-readable storage medium. Additionally, the functional blocks and devices of the system 100 are but one example of functional blocks and devices that can be implemented in an example. Specific functional blocks can be defined based on design considerations for a particular electronic device or system.

The system 100 can include a database server 102, in communication with clients 104, over a network 106. The database server 102 can include a processor 108, which can be connected through a bus 110 to a display device 112 to execute stored instructions. The processor 108 can be a single core processor, a multi-core processor, or any number of other configurations. Furthermore, the computing system 100 can include more than one processor 108. The display device 112 can include a display screen that is a built-in component of the computing system 100. The display device 112 can also include a computer monitor, television, or projector, among others, that is externally connected to the computing system 100.

The processor 108 can also be connected through the bus 110 to an input/output (I/O) device(s) 114, such as a mouse, a keyboard, or any other suitable type of I/O device. The I/O devices 114 can include, for example, a keyboard and a pointing device, wherein the pointing device can include a touchpad or a touchscreen, among others. The I/O devices 114 can be built-in components of the computing system 100, or can be devices that are externally connected to the computing system 100.

The processor 108 can also be connected through the bus 110 to a network interface card 116. The network interface card 116 can connect the database server 102 to the network 106. The network 106 can be a local area network, a wide area network, such as the Internet, or another network configuration. The network 106 can include routers, switches, modems, or any other kind of interface device used for interconnection. In one example, the network 106 can be the Internet.

The computing system 100 also includes a memory 118. The memory 118 is a physical memory such as a hard drive, an optical drive, an array of drives, random access memory (RAM), read only memory (ROM), or any combinations thereof, among others. The memory 118 can also include remote storage drives. In an example, the memory 118 can be a tangible, non-transitory, machine-readable medium. The memory 118 can include the machine readable instructions used in examples of the present techniques.

The memory 118 can include a query 120. In an example, the query 120 can be an SQL query. The query 120 can be included in a query plan. The client 104 can submit the query 120 to the database server 102 for execution. The memory 118 can also include a database management system (DBMS) 122. The DBMS 122 can be any suitable type of database management system. For example, the DBMS 122 can be PostgreSQL. The DBMS 122 can include a query executor 124. The query executor 124 executes an SQL query to access a NoSQL database. The query executor 124 can include multiple layers to execute the query 120. The layers of the query executor 124 can include a query analyzer layer to analyze an SQL query from a client, a row iterator layer to access the data requested in a query from an NoSQL database, and a translator layer to translate between the query analyzer and the row iterator. For example, employing a PostgreSQL DBMS 122 and DataSeries, the query executor 124 can include a foreign data wrapper (FDW) (i.e., query analyzer), a DataSeries (DS) row iterator (i.e., row iterator), and a translator to execute the query 120.

It is to be understood the block diagram of FIG. 1 is not intended to indicate that the computing system 100 is to include all of the components shown in FIG. 1 in every case. Further, any number of additional components can be included within the computing system 100, depending on the details of the specific implementation.

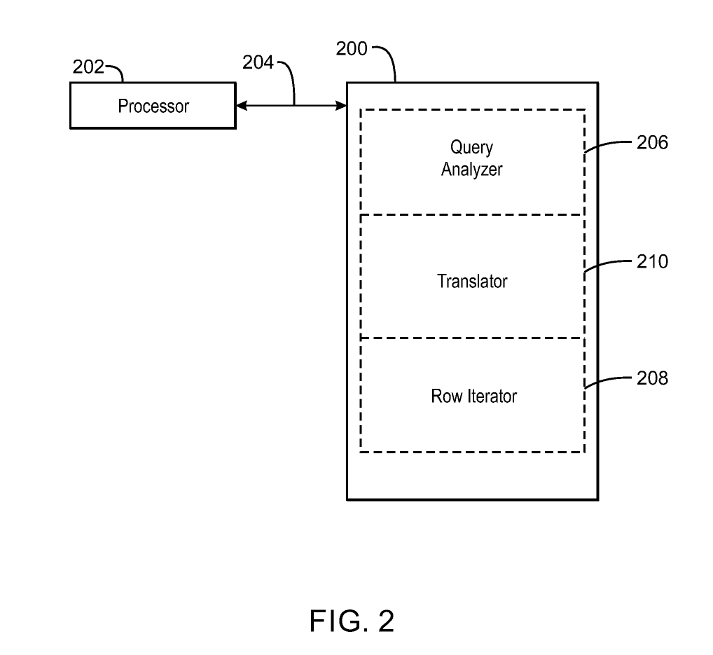

FIG. 2 is a block diagram of a tangible, non-transitory, machine-readable medium 200 containing code for processing an SQL query to access a NoSQL database in accordance with an example of the techniques of the present application. The machine-readable medium 200 can be any typical storage device that stores computer-implemented instructions, such as programming code or the like. For example, the machine-readable medium 200 can include random-access memory (RAM), a hard disk array, an array of hard disk drives, an optical drive, an array of optical drives, a non-volatile memory, a USB drive, a DVD, a CD, and the like. Moreover, the machine-readable medium 200 can be included in memory 118. When read and executed by a processor 202, the instructions stored on the machine-readable medium 300 cause the processor 202 to execute the stored instructions. The machine-readable medium 200 can be accessed by the processor 202 over a network or bus 204.

The machine-readable medium 200 can include code to execute an SQL query to access a NoSQL database. A first region of the machine-readable medium 200 can include a query analyzer 206 to analyze a query from a client. The query analyzer 206 can identify the qualifications of the query and the tables to which the query requests access. A region can include a row iterator 208 to access the NoSQL tables to retrieve the data requested in the query. Another region can include a translator 210 to translate between the query analyzer 206 and the row iterator 208. Additionally, the translator 210 instantiates the appropriate row iterator class based on the tables identified by the query analyzer 206.

In an example, a computing system can include a PostgreSQL database management system and can include DataSeries. In this system, the query analyzer 206 can be a foreign data wrapper (FDW). The FDW interfaces with the rest of PostgreSQL's query execution engine. The FDW parses the query's expression tree, looking for qualifications involving columns that comprise the search key. Only qualification with =, <, <=, >, >=, or LIKE operators are passed to the translator 210 because they can be used by the extent index search interface. Query qualifications that involve non-search key columns will not be passed to lower layers, because they cannot be leveraged by the extent index search interface. The FDW sets up the state required to use the row iterator 208 and the translator 210. Additionally, the FDW stores the results from the translator 210 in PostgreSQL tuple slots, for consumption by the rest of the query plan and handles rescans of the table during query execution.

In this system, the row iterator 208 can be a DataSeries (DS) row iterator. The DS row iterator 208 exposes the DataSeries extent index interface for equality, range, and set searches on the tables search key. The DS row iterator 208 maintains the extent state associated with a DS file, and implements the row iterator interface for opening the file, returning results one row at a time, and closing the file. The caller restricts the search by supplying a single value (equality search), minimum and maximum values (range search), or a vector of values (set search) to an initialization method before any rows are retrieved. Subsequent calls to retrieve a row will only examine the extents that meet the supplied criteria.

Because DS access routines are specific to the extents schema type, the row iterator 208 may be defined via a template and schema-type-specific classes are instantiated using schema-specific data parameters for search key fields and data fields. These key and data field classes and template instantiations can be automatically generated, such as from an XML schema specification. Additionally, in a pipelined, distributed database, the ingestion path can maintain its state for a table as a set of DataSeries files, an “authoritative” file and one or more “update” files. The row iterator 208 can merge rows from the authoritative and update files to provide an up-to-date view of the table.

Upon a request for the next row, the translator 210 retrieves a row from the row iterator 208 and performs schema-type-specific operations to translate the set of columns into data value formats that are understandable to PostgreSQL. Because of DataSeries's need for schema-type-specific code, the translator 210 can be automatically generated from the XML schema specification.

The translator 210 translates PostgreSQL's generic data types into data type-specific values. The translator 210 additionally examines the qualifications identified by the FDW 204 to determine whether to use an equality or range search. For one-sided numeric range queries, the translator 210 invokes type-specific code to fill in the appropriate missing value. The translator 210 also assembles multi-column search keys from individual column Boolean qualifications in the query.

Although shown as contiguous blocks, the software components can be stored in any order or configuration. For example, if the tangible, non-transitory, machine-readable medium 500 is a hard drive, the software components can be stored in non-contiguous, or even overlapping, sectors.

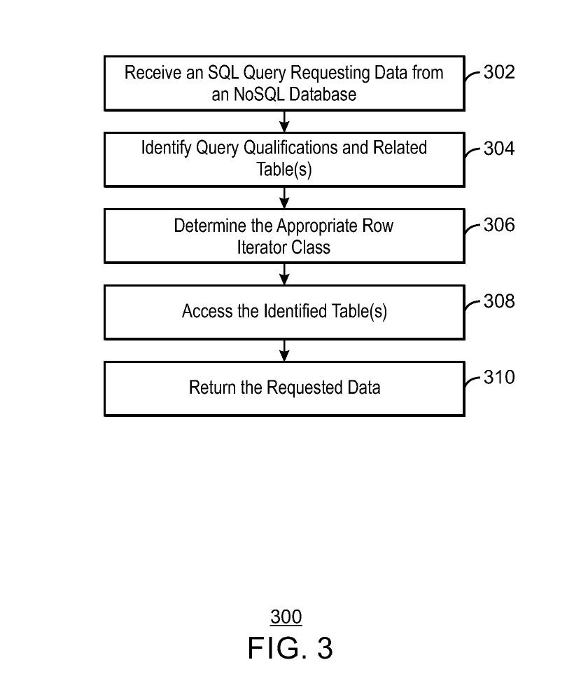

FIG. 3 is a process flow diagram of an example of a method 300 of processing an SQL query to access a NoSQL database in accordance with an example of the techniques of the present application. For example, the method 300 can be executed by the computing system described with respect to FIG. 1. At block 302, an SQL query requesting data from an NoSQL database can be received in a query executor, such as query executor 124. The query executor can be included in a database management system (DBMS), such as PostgreSQL. The SQL query can be included in a query plan received from a client.

At block 304, the query executor can identify query qualifications and related tables. The query qualifications and related tables can be identified by a query analyzer included in the query executor. For example, in a computing system employing PostgreSQL, the query analyzer can be a foreign data wrapper (FDW). The related tables can be the tables including the data to which the query requests access.

At block 306, the query executor can determine the appropriate row iterator class. For example, the query executor can employ a translator to determine the appropriate row iterator class. The row iterator class can be determined based on the identified related tables.

At block 308, the identified table(s) in the NoSQL database can be accessed to retrieve the requested data. The table(s) can be accessed by a row iterator. The row iterator can access the table(s) directly or through a network connection, such as the internet. The row iterator maintains the extent state associated with the NoSQL database. At block 310, the row iterator returns the requested data. The translator can translate the data into data value formats that are understandable by an SQL DBMS, such as PostgreSQL.

It is to be understood that the process flow diagram of FIG. 3 is not intended to indicate that the steps of the method 300 are to be executed in any particular order, or that all of the steps of the method 300 are to be included in every case. Further, any number of additional steps not shown in FIG. 3 can be included within the method 300, depending on the details of the specific implementation.

Some embodiments can be implemented in one or a combination of hardware, firmware, and software. Some embodiments can also be implemented as instructions stored on a machine-readable medium, which can be read and executed by a computing platform to perform the operations described herein. A machine-readable medium can include any mechanism for storing or transmitting information in a form readable by a machine, e.g., a computer. For example, a machine-readable medium can include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “can”, “might”, “may” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases can each have a same reference number or a different reference number to suggest that the elements represented could be different and/or similar. However, an element can be flexible enough to have different implementations and work with some or all of the systems shown or described herein. The various elements shown in the figures can be the same or different. Which one is referred to as a first element and which is called a second element is arbitrary.

It is to be understood that specifics in the aforementioned examples can be used anywhere in one or more embodiments. For instance, all optional features of the computing device described above can also be implemented with respect to either of the methods or the machine-readable medium described herein. Furthermore, although flow diagrams and/or state diagrams can have been used herein to describe embodiments, the inventions are not limited to those diagrams or to corresponding descriptions herein. For example, flow need not move through each illustrated box or state or in exactly the same order as illustrated and described herein.

What is claimed is:

1. A computing system, comprising:
a processor to execute stored instructions; and
a memory that stores instructions, the memory comprising:
computer-implemented code to receive a structured query language (SQL) query requesting data from a non-structured query language (NoSQL) database;
computer-implemented code to identify a query qualification and a related table in an NoSQL;
computer-implemented code to determine a row iterator class;
computer-implemented code to access the identified related table; and
computer-implemented code to return the requested data.

2. The computing system of claim 1, wherein a row iterator accesses a plurality of related tables to return the requested data.

3. The computing system of claim 1, wherein a query analyzer identifies the query qualification and the related table.

4. The computing system of claim 1, wherein a row iterator accesses the related table and returns the requested data and a query analyzer identifies the query qualification and the related table, and wherein a translator translates values between the row iterator and the query analyzer.

5. The computing system of claim 1, wherein the row iterator class is determined based on the related table.

6. A tangible, non-transitory, machine-readable storage medium, comprising code to direct a processor to:
receive, in a query executor, a structured query language (SQL) query requesting data from a non-structured query language (NoSQL) database;
identify a query qualification and a related table in a NoSQL database;
determine a row iterator class;
access the identified related table; and
return the requested data.

7. The tangible, non-transitory, machine-readable storage medium of claim 6, wherein the row iterator class is determined based on the related table.

8. The tangible, non-transitory, machine-readable storage medium of claim 6, wherein a query analyzer identifies the query qualification and the related table, a row iterator accesses the identified related table and returns the requested data, and wherein a translator translates between the query analyzer and the row iterator.

9. The tangible, non-transitory, machine-readable storage medium of claim 6, wherein the related table comprises the data requested in the SQL query.

10. A computer-implemented method, comprising:
receiving, in a processor, a structured query language (SQL) query requesting data from a non-structured query language (NoSQL) database;
identifying a query qualification and a related table in a NoSQL database;
determining a row iterator class;
accessing the related table with a row iterator; and
returning the requested data.

11. The computer-implemented method of claim 10, wherein the related table comprises the data requested by the SQL query.

12. The computer-implemented method of claim 10, wherein the row iterator class is determined based on the related table.

13. The computer-implemented method of claim 10, wherein the requested data is translated from a type specific data type to a general data type when the data is returned.

14. The computer-implemented method of claim 10, wherein a query analyzer identifies the query qualification and the related table.

15. The computer-implemented method of claim 14, wherein a translator translates between the query analyzer and the row iterator.
